(19) United States
(12) Patent Application Publication
(10) Pub. No.: US 2015/0296727 A1
(43) Pub. Date: Oct. 22, 2015

(54) ROTATABLE HYDROPONIC GROWTH SYSTEM

(71) Applicants: Albert Posthumus, Stephenville, TX (US); Eugene Norwood, Goldthwaite, TX (US)

(72) Inventors: Albert Posthumus, Stephenville, TX (US); Eugene Norwood, Goldthwaite, TX (US)

(21) Appl. No.: 14/256,193

(22) Filed: Apr. 18, 2014

(51) Int. Cl. A01G 31/06

(52) U.S. Cl. CPC A01G 31/06

(57) ABSTRACT

A hydroponic growing system includes a first rotatable platform for growing vegetation thereon, a seed dispenser and a harvester. The first rotatable platform is rotatable about a central axis and the seed dispenser is positionable adjacent to the rotatable platform to deposit seeds onto the rotatable platform. The seeds grow hydroponically into vegetation on the first platform. The harvester is positionable adjacent to the rotatable platform to remove the vegetation from the rotatable platform in response to rotation of the rotatable platform.

### TECHNICAL FIELD

This disclosure relates to a hydroponic system for growing vegetation, and, in particular, to a hydroponic system that includes at least one group of platforms that rotates around a central, vertical axis to position the platforms near a seed dispenser, a harvester and other mechanisms to grow and harvest vegetation on the platforms.

### BACKGROUND OF THE DISCLOSURE

Agricultural crops are typically grown in soil using traditional planting, growing and harvesting methods. Growing crops in this manner requires large areas of farm land, large volumes of water and fertilizer, specialized plowing, seeding and harvesting vehicles, and hours of manual labor to produce significant crop yields. Unfortunately, crop yields are often limited by unfavorable weather conditions or other environmental factors beyond the control of the farmer, and production of specific crops is often limited to specific growing seasons and geographic locations.

Hydroponic growing techniques are used to grow crops in a controlled environment to avoid the aforementioned problems. Generally, hydroponic techniques involve the growing of vegetation without soil by submersing seeds and/or plant roots in a mineral nutrient-enriched water solution or by spraying the seeds and/or plant roots with such a solution. The seeds/roots absorb nutrients from the solution and grow without the need for soil. While existing hydroponic growth techniques have addressed some of the problems with traditional soil-based agriculture, current hydroponic techniques require large amounts of physical labor, consume large amounts of electrical power, produce small crop yields and do not produce crops in a manner that is economically profitable.

### SUMMARY

In a first aspect, there is provided a hydroponic growing system that includes a first rotatable platform for growing vegetation thereon that is rotatable about a central axis, a seed dispenser positionable adjacent to the rotatable platform to deposit seeds onto the rotatable platform, and a harvester positionable adjacent to the rotatable platform to remove the vegetation from the rotatable platform in response to rotation of the rotatable platform. The seeds grow hydroponically into vegetation on the first platform are then removed by the harvester.

In some embodiments, the system includes a second rotatable platform that rotates about the central axis. The first rotatable platform includes a first opening and the second rotatable platform is located within the first opening of the first rotatable platform.

In other embodiments, the system includes a third rotatable platform that rotates about the central axis. The second rotatable platform includes a second opening and the third rotatable platform is located within the second opening of the second rotatable platform.

In another embodiment, the rotatable platform is coupled to one or more additional rotatable platforms that are vertically aligned with the first rotatable platform.

In still another embodiment, the first rotatable platform is circular and includes a first growing surface that is separated from a second growing surface by a wall.

In yet another embodiment, a first harvester removes vegetation from the first growing surface and a second harvester removes vegetation from the second growing surface.

In some embodiments, the system includes a vegetation evacuation mechanism adjacent to the harvester to receive vegetation that is removed from the first rotatable platform by the harvester.

In other embodiments, the first rotatable platform includes a removable wall coupled to a perimeter of the first rotatable platform.

In still other embodiments, the system includes one or more of a watering mechanism, a lighting-emitting mechanism and a fluid-emitting mechanism positioned adjacent to the first rotatable platform.

In a second aspect, there is described a hydroponic growing apparatus that includes a first platform and a second platform coupled to the first platform by a coupling member so that the second platform is vertically aligned with the first platform. The first and second platforms are rotatable about a central, vertical axis and each include a surface for hydroponically growing vegetation thereon. The coupling member maintains a distance between the first and second platforms so that vegetation can be grown simultaneously on the first and second platforms.

In some embodiments, the first platform and the second platform each include a first growing surface that is separate from a second growing surface by a wall.

In other embodiments, a distance from the circular walls to an interior edge of the first and second platforms is greater than a distance from the circular walls to an outer edge of the first and second rotatable platforms.

In still other embodiments, the first growing surface and the second growing surface of the first and second platforms are sloped away from the walls.

In another embodiment, the first and second rotatable platforms each include an interior removable sidewall and an exterior removable sidewall.

In a third aspect, there is provided a method for hydroponic growth of vegetation. The method includes providing a platform that includes a growing surface for hydroponically growing vegetation and rotating the platform about a central axis of the platform to align radial portions of the platform with at least one of a seed dispensing mechanism, a watering mechanism, a light-emitting mechanism and a harvesting mechanism.

In some embodiments, the method includes dispensing seeds from the seed dispensing mechanism on the platform as the platform rotates.

In other embodiments, the method includes dispensing fluid from the watering mechanism onto the seeds while the platform rotates.

In still other embodiments, the method includes removing vegetation from the platform using the harvester while the platform rotates.

In another embodiment, the method includes moving a pivotal arm of the harvester toward the platform to remove vegetation from the platform.

In still another embodiment, the method includes moving harvested vegetation on a conveyor.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE FIGURES

The accompanying drawings facilitate an understanding of the various embodiments.

FIG. 1 is a schematic cutaway side view of a hydroponic growing system in accordance with this disclosure.

FIG. 2 is a schematic top view of a hydroponic growing system in accordance with this disclosure.

FIG. 3 is a perspective side view of an embodiment of a platform with removable walls in accordance with this disclosure.

FIG. 4 is a perspective view of a group of removable wall segments in accordance with this disclosure.

FIG. 5 is a schematic, cutaway side view of a rotatable group of platforms with seeds and vegetation on the platforms in accordance with this disclosure.

FIG. 6 is a perspective view of another embodiment of a hydroponic growing system with vegetation on the platforms in accordance with this disclosure.

FIG. 7 is a cutaway, perspective view of another embodiment of a hydroponic growing system with removable trays in accordance with this disclosure.

### DETAILED DESCRIPTION

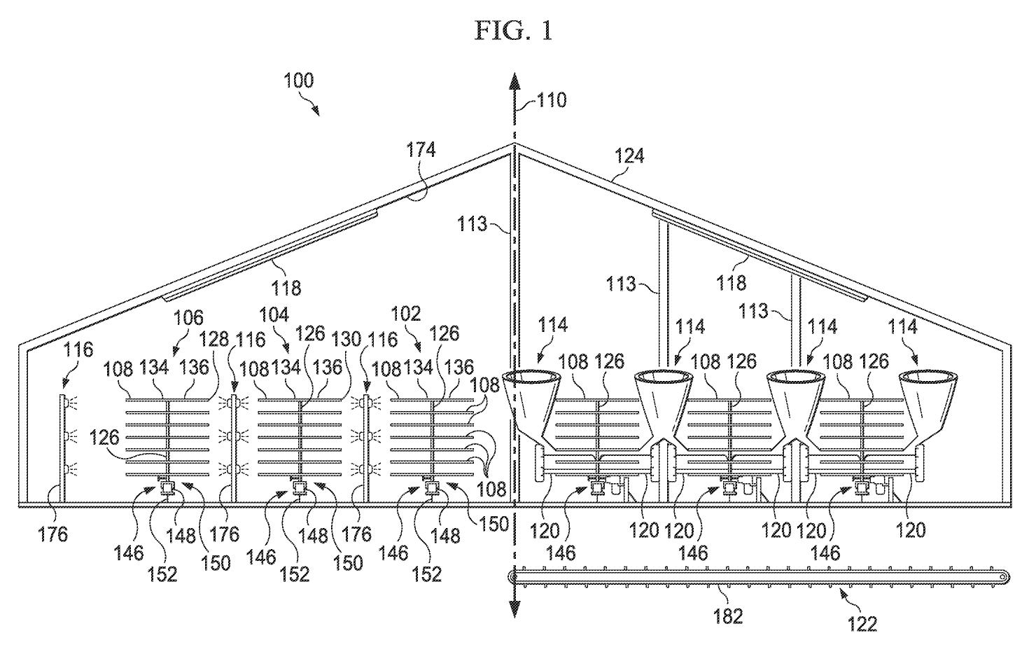

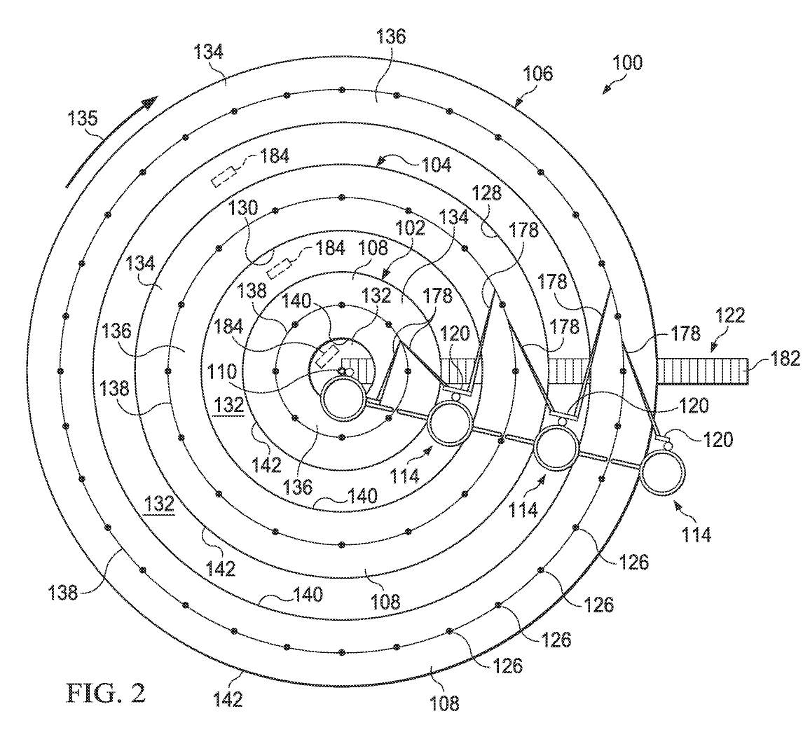

FIGS. 1 and 2 illustrate a rotatable hydroponic system 100 that overcomes many of the aforementioned shortcomings of existing hydroponic techniques and soil-based agriculture. In the embodiments illustrated in FIGS. 1 and 2, the hydroponic system 100 includes first, second and third rotatable groups 102, 104 and 106, respectively, of platforms 108 that rotate around a central, vertical axis 110 to automatically position growing surfaces 134 and 136 of the platforms 108 near dispensers 114, watering mechanisms 116, lighting mechanisms 118, and harvesters 120 that are positioned to interact with vegetation on each of the growing surfaces 134 and 136. As will be described in greater detail below, the vegetation is planted, grown and harvested on the growing surfaces 134 and 136 of the platforms 108 using minimal human labor. The concentric orientation of the rotatable groups 102, 104 and 106, as well as the vertically stacked orientation of the platforms 108 of each group 102, 104 and 106, provides for a space-efficient system 100 that consumes very little power during its operation. The system 100 also includes a vegetation evacuation mechanism 122 positioned beneath the rotatable groups 102, 104 and 106 to automatically remove harvested vegetation from the system 100 to a convenient location for storage, shipment or use. As described in more detail below, the system 100 can be configured to yield crops at regular time intervals, such as, for example, once a day, so that fresh crops are available on a regular basis.

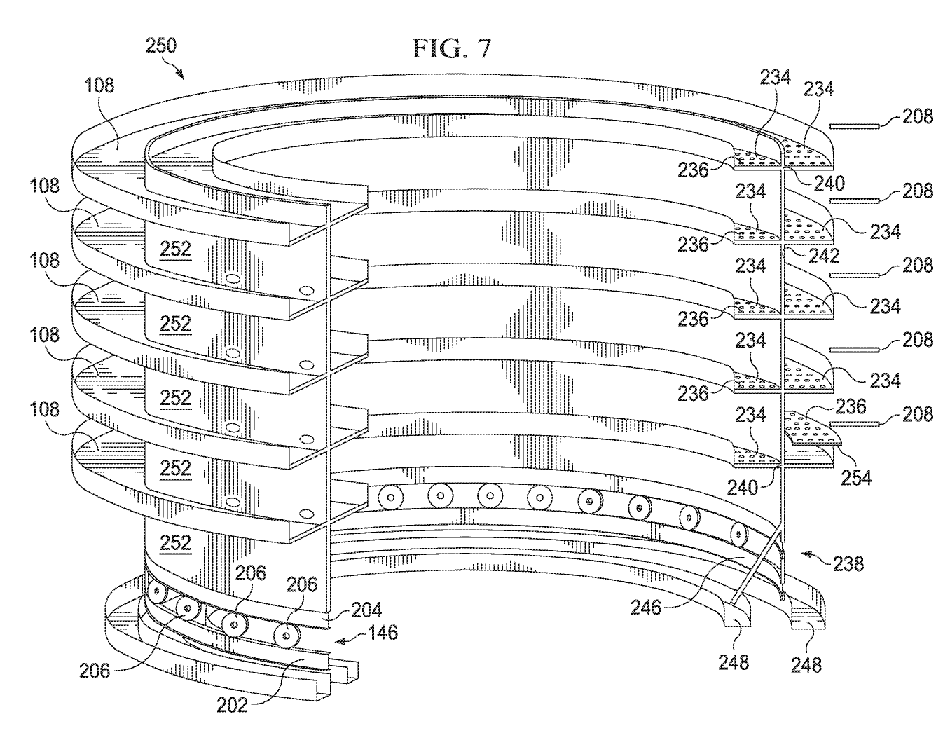

As shown in FIG. 1, the first, second and third rotatable groups 102, 104 and 106 of platforms 108 rotate about a central, vertical axis 110 and are housed in a building 124 so that the system 100 is separated from an exterior environment. In FIG. 1, the central, vertical axis 110 is aligned with a central, vertical post 113 of the building 124. In other embodiments, the central, vertical axis 110 is aligned with other areas of the building 124. Each rotatable group 102, 104 and 106 includes a plurality of annular platforms 108 that are coupled together by coupling mechanisms 126, such as one or more posts. In FIG. 1, the first, second and third groups 102, 104 and 106 each include seven platforms 108 that are coupled together by vertical coupling mechanisms 126. As shown in FIG. 1, the coupling mechanisms 126 maintain a vertical distance between adjacent platforms 108 to allow room for vegetation to grow on growing surfaces 134 and 136 of each platform 108 and to allow entry of at least part of a dispenser 114 and/or a harvester 120 between the vertically adjacent platforms 108. In other embodiments, each rotatable group 102, 104 and 106 includes more or less than seven platforms 108. In some embodiments, the system 100 includes more or less than three rotatable groups 102, 104 and 106. The coupling mechanisms 126 can be any suitable member for coupling the platforms 108 to each other. For example, in the embodiment shown in FIG. 1, the coupling mechanisms 126 are posts. In the embodiment shown in FIG. 7, the coupling mechanism 252 is a solid wall.

Referring specifically to FIG. 2, the first and second groups 102 and 104 are located within a central opening 128 of the third group 106, and the first group 102 is located within a central opening 130 of the second group 104. The concentric orientation of the groups 102, 104 and 106, in conjunction with the vertically stacked orientation of the platforms 108 in each group 102, 104 and 106, reduces the overall square footage necessary to produce a required amount of crop and allows stationary dispensers 114, watering mechanisms 116 (FIG. 1), lighting mechanisms 118 (FIG. 1) and harvesters 120 to conveniently and, in some embodiments, automatically interact with a full circumference of the platforms 108 as the groups 102, 104 and 106 rotate about the central axis 110. In addition, a farmer or other worker can easily view the platforms 102, 104 and 106 and the vegetation 112 growing thereon by walking on pathways 132 between the rotatable groups 102, 104 and 106 while the groups 102, 104 and 106 rotate or while the groups 102, 104 and 106 are stationary.

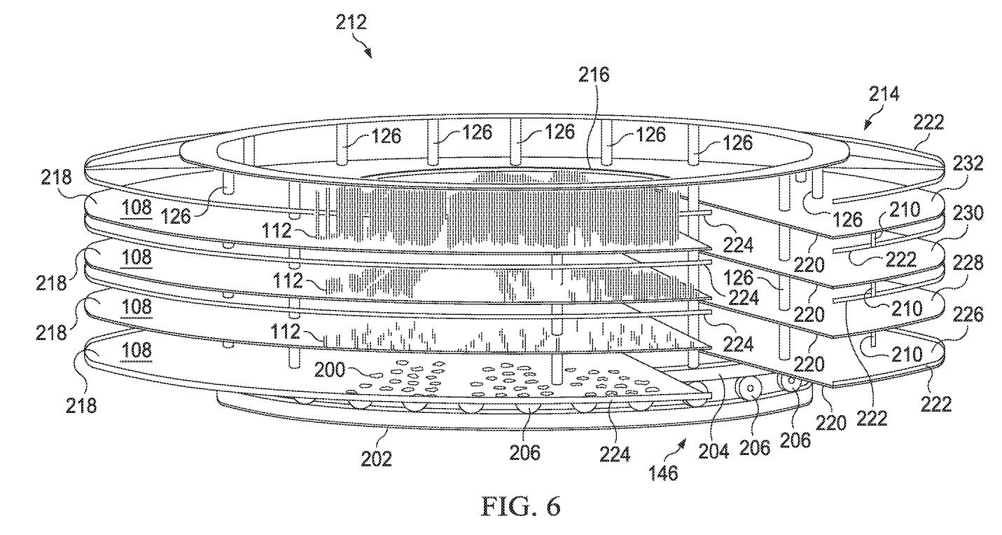

Referring again to FIG. 2, each platform 108 is subdivided into an outer growing surface 134 and an inner growing surface 136 by a circular wall 138 positioned about halfway between an inner edge 140 and an outer edge 142 of the platforms 108. In some embodiments, the wall 138 is offset so that the outer growing surface 134 extends a shorter distance from the wall 138 than the inner growing surface 136 to balance the weight of the platforms 108 on the coupling mechanisms 126. In some embodiments, the platforms 108, coupling mechanisms 126 and walls 138 are made of a rust-resistant, food-grade material. In some embodiments, the platforms 108 do not include a wall 138 and an entire surface of the platforms is a single growing surface, as shown in FIGS. 1 and 6.

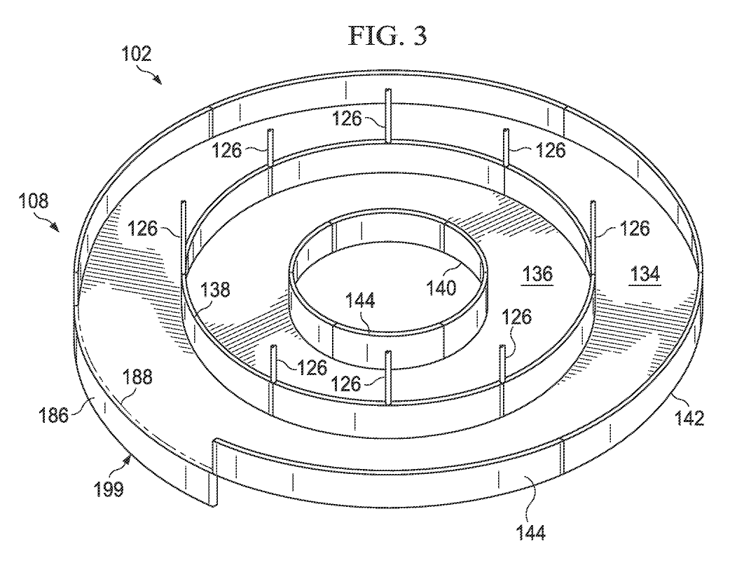

In FIG. 1, the platforms 108 are level and include solid growing surfaces 134 and 136 to retain water or other liquids on the platforms 108. In other embodiments, the platforms 108 slant or taper away from the coupling mechanisms 126 and/or the wall 138 (FIG. 2) so that fluids drain from the platforms 108. In other embodiments, the platforms 108 include openings (not shown) or other draining mechanisms to drain fluids from the platforms 108 and to allow airflow through the platforms 108. In some embodiments, liquids from the platforms 108 drains through the coupling members 126, as will be described in more detail below in connection with FIG. 7. In some embodiments, the platforms 108 include removable walls 144 (FIGS. 3, 4 and 5) to retain seed material 200, vegetation 112 and/or fluids on the platforms 108 when the removable wall 144 is secured in an upright position on the platforms 108.

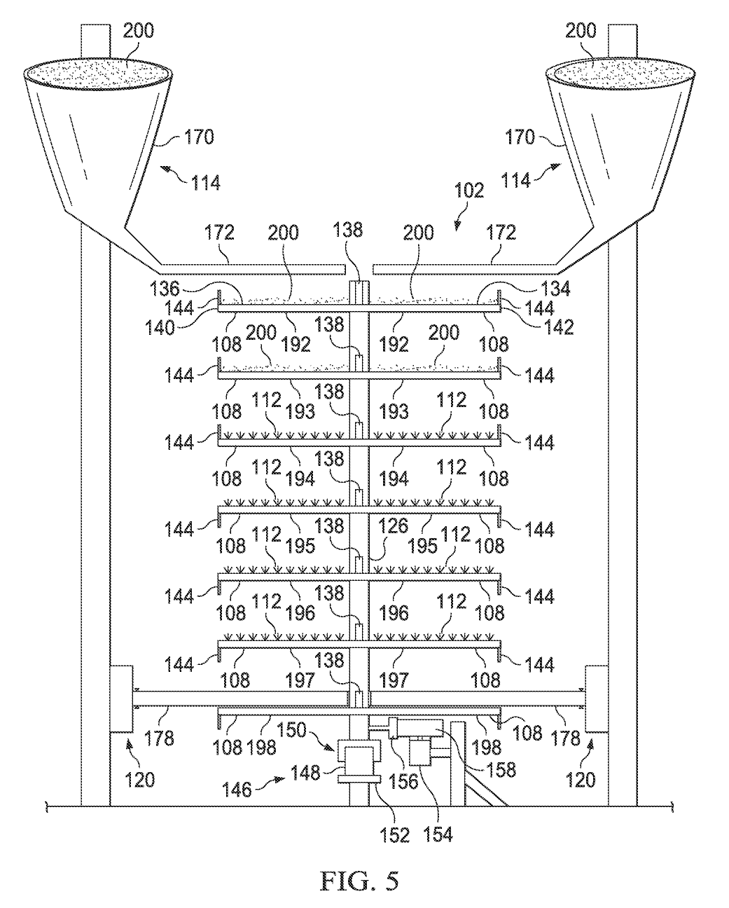

Referring still to FIG. 1, each rotating group 102, 104 and 106 includes a rotation mechanism 146 to allow the rotating group 102, 104 and 106 to rotate about the central axis 110. In the embodiment of FIG. 5, for example, each coupling mechanism 126 includes a wheel 148 rotatably coupled to a bottom end 150 of each coupling mechanism 126. The wheel 148 rotates on a circular track 152 located below the group 102, 104 and 106. In the embodiments illustrated in FIGS. 6 and 7, the rotation mechanism 146 includes a first track 202 located below the group 102, 104 or 106 and a second track 204 coupled to the coupling mechanisms 126 and 252. A plurality of bearings 206 located between the first track 202 and the second track 204 allow the second track 204 to move with respect to the first track 202 in a manner similar to a ball bearing. In other embodiments, the rotation mechanism 146 includes an annular flotation device (not shown) coupled to the group 102, 104 or 106 and a stationary annular trough (not shown) having water or some other fluid to buoyantly support the floatation device therein so that the flotation device is rotatable in the trough. One of ordinary skill in the art will recognize other suitable rotation mechanisms that can be used to allow the groups 102, 104 and 106 to rotate about the central vertical axis 110.

Referring again to FIG. 5, in some embodiments the system 100 also includes a drive motor 154 that interacts with a motor interface 156 in the shape of a circular I-beam coupled to the rotatable group 102 to rotate the group 102. In some embodiments, the motor 154 includes a wheel 158 that contacts the motor interface 156 so that when a user actuates the motor 154 the wheel 158 imparts rotational motion to the motor interface 156 and the first group 102. In some embodiments, the motor 154 requires very little energy to rotate the first group 102 because the group 102 includes one or more rotation mechanisms 146 that provide for a very low resistance to rotation. One of ordinary skill in the art will recognize other suitable mechanisms to impart rotational force to the groups 102, 104 and 106.

The system 100 includes various mechanisms that interact with the groups 102, 104 and 106 to plant, hydroponically grow and harvest vegetation on the growing surfaces 134 and 136 of the platforms 108. In FIG. 1, for example, the system 100 includes four dispensers 114 that are located adjacent to the groups 102, 104 and 106 to selectively deposit seeds or other agricultural material onto the growing surfaces 134 and 136. Referring to FIG. 5, each dispenser 114 includes a hopper 170 to store seed material 200 and a pivotable spout arm 172 to position the seed material 200 on the growing surfaces 134 and 136. In some embodiments, the dispensers 114 are adjustable in elevation to dispense material 200 onto each of the platforms 108 of the group 102 and may be coupled to a vertical post 113 for vertical adjustment thereon. In FIG. 5, for example, the dispensers 114 are positioned above the first platform 192 to deposit material 200 onto the growing surfaces 134 and 136 of the first platform 192. The dispensers 114 remain stationary while the rotatable group 102 rotates about the central, vertical axis 110 (FIG. 1) so that the dispensers 114 deposit material 200 on the full circumference of the growing surfaces 134 and 136 of the first platform 192. The dispensers 114 are adjustable to position the arms 172 on each of the platforms 192-198, as will be described in more detail below.

Referring again to FIG. 1, the system 100 also includes watering mechanisms 116 that are positioned to deposit water or other fluids onto the growing surfaces 134 and 136. In FIG. 1, the watering mechanisms 116 are coupled to free-standing polls 176 located adjacent to the platforms 108. In some embodiments, the watering mechanisms 116 include arms 208 to position fluids directly onto the growing surfaces 134 and 136 of the platforms 108, as shown in FIG. 7. In other embodiments, the watering mechanisms 116 are coupled to a ceiling 174 of the building 124. In other embodiments, the watering mechanisms 116 are transportable to allow a user to selectively position the watering mechanisms 116 with respect to the groups 102, 104 and 106. In some embodiments, the watering mechanism 116 has multiple outputs, such as multiple spray nozzles, so that the watering mechanism 116 simultaneously waters multiple growing surfaces 134 and 136. In some embodiments, the watering mechanisms 116 emit water, one or more mineral nutrient solutions and/or fertilizer.

The system 100 also includes lighting mechanisms 118 to provide light to the growing surfaces 134 and 136. In FIG. 1, the lighting mechanisms 118 couple to the ceiling 174 of the building 124. In other embodiments, lighting mechanisms 118 are fixed to the free-standing polls 176. In some embodiments, the lighting mechanisms 118 emit artificial light, natural light or a combination of natural and artificial light. In some embodiments, for example, the lighting mechanisms 118 include sky lights, windows or other openings in the building 124 to allow natural light to reach the growing surfaces 134 and 136. In some embodiments, the lighting mechanisms 118 are transportable so that a user can selectively position the lighting mechanisms 118 with respect to the platforms 108.

The system 100 also includes harvesters 120 to selectively remove vegetation 112 from the growing surfaces 134 and 136. In FIG. 1, the harvesters 120 each include an arm 178 that is pivotable from a disengaged position to an engaged position (FIGS. 1, 2 and 5) in which the arm 178 contacts the vegetation 112 that has grown on a growing surface 134 or 136 and forces the vegetation 112 off of the growing surface 134 or 136 and onto the vegetation evacuation mechanism 122. As shown in FIG. 2, the arms 178 contact the circular walls 138 when the arms 178 are in the engaged position.

The harvesters 120 are vertically adjustable for positioning on each platform 108 of the rotatable groups 102, 104 and 106. In FIG. 5, for example, the harvesters 120 are positioned on the seventh platform 198. When vegetation 112 is to be harvested from another platform 108, the arm 178 is pivoted away from the current platform 108, the harvester 120 is vertically aligned with the new platform 108, and the arm 178 is pivoted toward the new platform 108 until the arm 178 contacts the growing surface 134 or 136 and the circular wall 138 of the platform 108.

Referring again to FIGS. 1 and 2, in some embodiments the system 100 also includes a vegetation evacuation mechanism 122 positioned adjacent to the harvesters 120 to receive vegetation 112 that the harvesters 120 remove from the growing surfaces 134 and 136. The vegetation evacuation mechanism 122 extends from a center of the groups 102, 104 and 106 to an exterior of the building 124 and includes a conveyor that includes a movable belt 182 to transport the harvested vegetation 112. When the movable belt 182 is engaged, the evacuation mechanism 122 automatically removes vegetation 112 from the building 124, thus greatly reducing the amount of manual labor required to harvest the vegetation 112. In the embodiment illustrated in FIG. 1, the vegetation evacuation mechanism 122 is level and is located below ground level. In other embodiments, the vegetation evacuation mechanism 122 is sloped and/or located at or above ground level.

Referring again to FIG. 2, in some embodiments the system 100 also includes air movement devices 184 to increase air flow within the building 124. In some embodiments, the air movement devices 184 are positioned on the pathways 132 and/or the building 124.

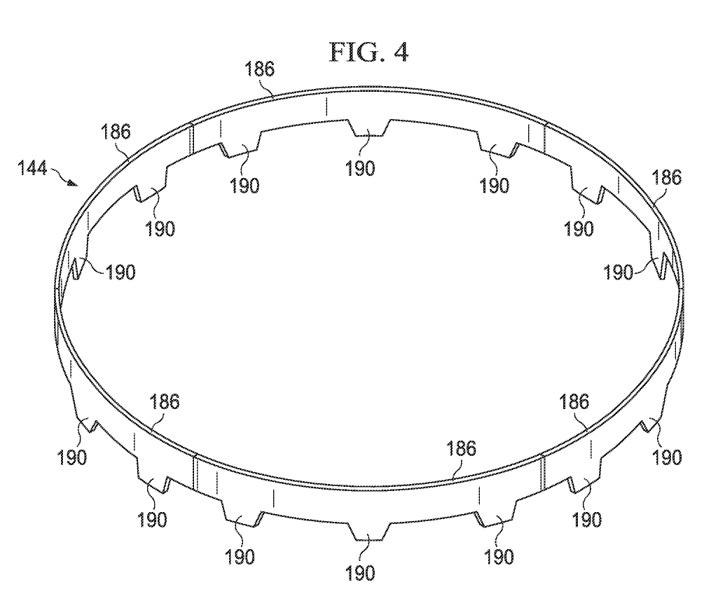

Referring now to FIGS. 3 and 4, in some embodiments the system 100 includes removable walls 144 that are coupleable to the platforms 108. The removable walls 144 are made up of a plurality of wall segments 186 that are removably coupleable to the inner and outer edges 140 and 142 of the platforms 108. In some embodiments, the platforms 108 includes slots 188 (FIG. 3) adjacent to the inner and outer edges 140 and 142 to receive protrusions 190 (FIG. 4) on the wall segments 186 to hold the wall segments 186 in an upright orientation on the platform 108. In some embodiments, the wall segments 186 are also positionable in a hanging orientation from the platforms 108, as shown by wall segment 199, when the wall segment 199 is not in use, such as, for example, during a harvesting operation.

Referring now to FIG. 5 and Table 1 (shown below), the system 100 allows for simultaneous planting, growing and harvesting of vegetation 112 to produce crops at regular intervals.

TABLE 1

| | Platform 1 | Platform 2 | Platform 3 | Platform 4 | Platform 5 | Platform 6 | Platform 7 |
|---|---|---|---|---|---|---|---|
| Day 1 | Plant Seeds | | | | | | |
| | Water | | | | | | |
| Day 2 | Water | Plant Seeds | | | | | |
| | | Water | | | | | |
| Day 3 | Water | Water | Plant Seeds | | | | |
| | | | Water | | | | |
| Day 4 | Water | Water | Water | Plant Seeds | | | |
| | | | | Water | | | |
| Day 5 | Water | Water | Water | Water | Plant Seeds | | |
| | | | | | Water | | |
| Day 6 | Water | Water | Water | Water | Water | Plant Seeds | |
| | | | | | | Water | |
| Day 7 | Harvest | Water | Water | Water | Water | Water | Plant Seeds |
| | | | | | | | Water |
| Day 8 | Plant Seeds | Harvest | Water | Water | Water | Water | Water |
| | Water | | | | | | |
| Day 9 | Water | Plant Seeds | Harvest | Water | Water | Water | Water |
| | | Water | | | | | |
| Day 10 | Water | Water | Plant Seeds | Harvest | Water | Water | Water |
| | | | Water | | | | |
| Day 11 | Water | Water | Water | Plant Seeds | Harvest | Water | Water |
| | | | | Water | | | |
| Day 12 | Water | Water | Water | Water | Plant Seeds | Harvest | Water |
| | | | | | Water | | |
| Day 13 | Water | Water | Water | Water | Water | Plant Seeds | Harvest |
| | | | | | | Water | |
| Day 14 | Harvest | Water | Water | Water | Water | Water | Plant Seeds |
| | | | | | | | Water |

On Day 1, for example, the dispenser 114 is positioned over the first platform 192 and the removable walls 144 are removably secured to the first platform 192 in an upright orientation to hold the seed material 200 on the first platform 192. The dispenser 114 deposits seed material 200 on the full circumference of the growing surfaces 134 and 136 of the first platform 192 as the first group 102 rotates one full rotation. In some embodiments, the watering mechanism 116 waters the seed material 200 on first platform 192 while the first group 102 rotates one full rotation. In other embodiments, the dispenser 114 dispenses seed material 200 during a first full rotation on Day 1 and the watering mechanism 116 dispenses water on the seed material 200 during a second full rotation on Day 1. In some embodiments, the first group 102 rotates an additional full rotation at a later time during Day 1 to allow the watering mechanism 116 to apply a second amount of fluid to the seed material 200.

On Day 2, the dispensers 114 are re-positioned to deposit seed material 200 on the second platform 193. In some embodiments, a user manually adjusts the position of the dispensers 114 and the spout arms 172 while in other embodiments the system 100 automatically adjusts the position of the dispensers 114 and the spout arms 172. The spout arms 172 of the dispensers 114 pivot away from the first group 102 and the dispensers 114 lower to a position between the first and second platforms 192 and 193. The spout arms 172 then pivot toward the first group 102 to position the spout arms 172 over the second platform 193. The first group 102 rotates while the dispensers 114 dispense seeds on the growing surfaces 134 and 136 of the second platform 193 and the watering mechanism 116 applies a fluid to the first and second platforms 192 and 193 of the second platform 193. The first group 102 rotates again later during Day 2 to provide additional liquid to the first and second platforms 192 and 193.

In a similar manner to that described above, the dispensers 114 deposit seed material 200 on the third through the seventh platforms 194-198 on days 3-7, respectively, and the watering mechanisms 116 water the seed material 200 on the platforms 192-198. In some embodiments, the lighting mechanisms 118 apply light continuously to the seed material 200, while in other embodiments the lighting mechanisms 118 selectively apply light to the seed material 200.

Once the seed material 200 has grown to a point at which it is stable on the platforms 108, the removable walls 144 are removed and hung from an underside of the platforms 108, as shown by removable walls 144 coupled to the fourth, fifth, sixth and seventh platforms 195-198 in FIG. 5. In some embodiments, for example, the wall segments 186 of the removable walls 144 include openings (not shown) that are placed over hooks 210 (FIG. 6) on the inner and outer edges 140 and 142 of the platforms 108 to hang the wall segments 186. As such, the wall segments 186 are easily accessible for replacement in the upright orientation for the following growing cycle. In some embodiments, removal of the wall segments 186 allows for greater airflow to the vegetation 112 and allows the arms 178 of the harvester 120 to remove vegetation 112 during a harvesting operation.

The seed material 200 placed on the first platform on Day 1 grows to produce vegetation during Days 2-7. Certain vegetation, such as, for example, certain types of fodder for domestic livestock, is fully grown, or at least grown to the point that it can be consumed, within seven days. Thus, on Day 7, the vegetation on the first platform 192 is ready to harvest. On Day 7, the harvesters 120 are positioned on the first platform 192 and the arms 178 contact the first and second growing surfaces 134 and 136 to remove the vegetation 112. As the group 102 rotates in the direction of arrow 135 (FIG. 2), the arm 178 forces the vegetation 112 off the first platform 192 and onto the vegetation evacuation mechanism 122.

On Day 8, the spout arm 172 of the dispenser 114 is positioned over the first platform 192 to dispense seed material 200 onto the first platform 192 during rotation thereof to restart the growth cycle on the first platform 192. Further, the vegetation 112 on the second platform 193 is ready for harvesting. As such, the arms 178 of the harvesters 120 are positioned onto the second platform 193 and the first group 102 rotates so that the harvesters 120 remove or otherwise push the vegetation 112 from the second platform 193. As the group 102 rotates in the direction of arrow 135 (FIG. 2), the arm 178 forces and/or otherwise pushes the vegetation 112 off the second platform 193 and onto the vegetation evacuation mechanism 122. On Days 9-14, the process described above repeats for the third through seventh platforms 194-198 so that each platform 194-198 is harvested and re-planted. As such, the system 100 produces freshly harvested vegetation 112 once per day to supply a regular supply of vegetation. An embodiment of Day 13 is shown in FIG. 5.

In some embodiments, the system 100 has more than one harvester 120 and dispenser 114 per growing surface 134 or 136 to allow for planting and/or harvesting with less than a full rotation of the groups 102, 104 and 106. In some embodiments, the groups 102, 104 and 106 rotate only when necessary to receive seed material 200 or water or during a harvesting operation to conserve energy required to run the motor 154. In other embodiments, the groups 102, 104 and 106 rotate continuously and are sized such that vegetation 112 is fully grown during a single rotation of the groups 102, 104 and 106. In some embodiments, the groups 102, 104 and 106 can rotate together or separately, as needed.

FIG. 6 is a perspective view of another embodiment of a hydroponic growing system 212 with seed material 200 and/or vegetation 112 on the platforms 108. The system 212 includes a single group 214 that includes four platforms 108. In other embodiments, the single group 214 includes more or less than four platforms 108. The platforms 108 are vertically aligned and are connected by vertical coupling mechanisms 126. The platforms 108 are annular in shape and each includes a central opening 216. In some embodiments, the platforms 108 do not include a wall 138 and thus have a single growing surface 218 that extends from an inner edge of the platform 108 to an outer edge of the platform 108. In the embodiment shown in FIG. 6, each platform 108 includes a cutout portion 220 to allow a user to enter into the central openings 216 of the platforms 108. The cutout portions 220 of the platforms 108 are aligned such that a user can walk within the cutout portions 220 to access vegetation 112 that is growing near the central openings 216 of the platforms 108. In the embodiment of FIG. 6, the platforms 108 are about 20 feet in diameter.

In some embodiments, a user manually plants and harvests vegetation 112 on the platforms 108 of the system 212 while the platforms 108 rotate. For example, in some embodiments a user accesses the central openings 216 through the cutout portions 220 of the platforms 108. The user remains at a fixed location within the openings 216 while the platforms 108 rotate around the user. The user can remain at the fixed location while placing seed material 200 on an inner portion of the platforms 108 or harvesting vegetation 112 from the inner portion of the platforms 108. In some embodiments, the same user or another user places seed material 200 on an outer portion of the platforms 108 and/or harvests vegetation 112 from the outer portion of the platforms 108. In other embodiments, a single user places seed material 200 on the entire growing surface 218 from a single location inside the openings 216 or a single location outside of the platforms 108. Automatic or manual watering mechanisms 116 (FIG. 1) and lighting mechanisms 118 (FIG. 1) apply fluid and light, respectively, to the seed material 200. To harvest vegetation 112 that has grown on the growing surfaces 218, the platforms 108 rotate while the user manually removes the vegetation 112 from the platforms 108. Once again, the user remains in a single location while removing vegetation 112 from the platforms 108.

In some embodiments, the system 212 includes one or more dispensers 114 (FIG. 1) and harvesters 120 (FIG. 1) located adjacent to the platforms 108. In some embodiments, the user manually operates the dispensers 114 and the harvesters 120 while in other embodiments the dispensers 114 and the harvesters 120 are automatically or semi-automatically operated. In some embodiments, the system 212 does not include a vegetation evacuation mechanism 122 (FIG. 1) and one or more users manually transport vegetation 112 from the system 212. In other embodiments, the system 212 includes a vegetation evacuation mechanism 122 located below the platforms 108.

In the embodiment of FIG. 6, the removable walls 222 are each a unitary piece of material that extends along the circumference of the platforms 108 and includes a break 224 corresponding to the cutaway portions 220 of the platforms 108. In some embodiments, the removable walls 222 include wall segments (not shown) similar to the removable wall segments 186 in FIG. 4. The removable walls 222 are securable in an upright position on the platforms 108, as shown on the first platform 226, and are securable underneath the platforms 108 by hooks 210 positioned under the platforms 108, as shown on the third 230 and fourth platforms 232.

FIG. 7 is a cutaway, perspective view of another embodiment of a hydroponic growing system 250 that includes removable trays 234 to hold seed material 200 and/or vegetation 112 on the platforms 108. The removable trays 234 rest on the platforms 108 and are spaced above the platforms 108 to allow fluid to drain from the removable trays 234 onto the platforms 108. The removable trays 234 include openings 236 to receive vegetation 112 and/or seed material 200 therein and to maintain a distance between adjacent vegetation 112 and/or seed material 200. When the vegetation 112 is to be harvested, the removable trays 234 are either manually or automatically removed from the platforms 108, as shown by the removable platform 254 in FIG. 7, and the vegetation 112 is removed from the trays 234. In some embodiments, the vegetation 112 is harvested from the trays 234 without removing the trays 234 from the platforms 108.

FIG. 7 also shows a draining system 238 to drain fluids from the platforms 108. The draining system 238 includes openings 240 in the coupling mechanism 252 to allow fluid from the platforms 108 to pass into a fluid pathway 242 within the coupling mechanism 126. The fluid pathway 242 connects the openings 240 to a fluid conduit 246 that transports the fluid to a fluid retention mechanism 248, which may be, for example, one or more troughs. In some embodiments, fluid from the fluid retention mechanism 248 is recycled and re-deposited onto the platforms 108 by the arms 208 of the watering mechanisms 116.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A hydroponic growing system, comprising:
a first rotatable platform for growing vegetation thereon that is rotatable about a central axis;
a seed dispenser positionable adjacent to the rotatable platform to deposit seeds onto the rotatable platform, wherein the seeds grow hydroponically into vegetation on the first platform; and
a harvester positionable adjacent to the rotatable platform to remove the vegetation from the rotatable platform in response to rotation of the rotatable platform.

2. The hydroponic growing system according to claim 1, further comprising a second rotatable platform that rotates about the central axis, wherein the first rotatable platform comprises a first opening and the second rotatable platform is located within the first opening of the first rotatable platform.

3. The hydroponic growing system according to claim 2, further comprising a third rotatable platform that rotates about the central axis, wherein the second rotatable platform comprises a second opening and the third rotatable platform is located within the second opening of the second rotatable platform.

4. The hydroponic growing system according to claim 1, wherein the rotatable platform is coupled to one or more additional rotatable platforms that are vertically aligned with the first rotatable platform.

5. The hydroponic growing system according to claim 1, wherein the first rotatable platform is circular and includes a first growing surface that is separated from a second growing surface by a wall.

6. The hydroponic growing system according to claim 5, wherein a first harvester removes vegetation from the first growing surface and a second harvester removes vegetation from the second growing surface.

7. The hydroponic growing system according to claim 1, further comprising a vegetation evacuation mechanism adjacent to the harvester to receive vegetation that is removed from the first rotatable platform by the harvester.

8. The hydroponic growing system according to claim 1, wherein the first rotatable platform comprises a removable wall coupled to a perimeter of the first rotatable platform.

9. The hydroponic growing system according to claim 1, further comprising one or more of a watering mechanism, a lighting-emitting mechanism and a fluid-emitting mechanism positioned adjacent to the first rotatable platform.

10. A hydroponic growing apparatus, comprising:
a first platform and a second platform coupled to the first platform by a coupling member so that the second platform is vertically aligned with the first platform;
wherein the first and second platforms are rotatable about a central, vertical axis and each include a surface for hydroponically growing vegetation thereon; and
wherein the coupling member maintains a distance between the first and second platforms so that vegetation can be grown simultaneously on the first and second platforms.

11. The hydroponic growing apparatus according to claim 10, wherein the first platform and the second platform each include a first growing surface that is separate from a second growing surface by a wall.

12. The hydroponic growing apparatus according to claim 11, wherein a distance from the circular walls to an interior edge of the first and second platforms is greater than a distance from the circular walls to an outer edge of the first and second rotatable platforms.

13. The hydroponic growing apparatus according to claim 11, wherein the first growing surface and the second growing surface of the first and second platforms are sloped away from the walls.

14. The hydroponic growing apparatus according to claim 10, wherein the first and second rotatable platforms each include an interior removable sidewall and an exterior removable sidewall.

15. A method for hydroponic growth of vegetation, comprising:
providing a platform that includes a growing surface for hydroponically growing vegetation; and
rotating the platform about a central axis of the platform to align radial portions of the platform with at least one of a seed dispensing mechanism, a watering mechanism, a light-emitting mechanism and a harvesting mechanism.

16. The method according to claim 15, further comprising dispensing seeds from the seed dispensing mechanism on the platform as the platform rotates.

17. The method according to claim 16, further comprising dispensing fluid from the watering mechanism onto the seeds while the platform rotates.

18. The method according to claim 15, further comprising removing vegetation from the platform using the harvester while the platform rotates.

19. The method according to claim 18, further comprising moving a pivotal arm of the harvester toward the platform to remove vegetation from the platform.

20. The method according to claim 15, further comprising moving harvested vegetation on a conveyor.
